(19) United States
(12) Patent Application Publication
(10) Pub. No.: US 2006/0040404 A1
(43) Pub. Date: Feb. 23, 2006

(54) Inkjet spotting apparatus for manufacturing microarrays and method of spotting using the same

(76) Inventors: Ji-hyuk Lim, Gyeonggi-do (KR); Dong-kee Sohn, Seoul (KR); Min-soo Kim, Seoul (KR); Keon Kuk, Gyeonggi-do (KR)

Correspondence Address: CANTOR COLBURN, LLP, 55 GRIFFIN ROAD SOUTH, BLOOMFIELD, CT, 06002, US

(21) Appl. No.: 11/204,489

(22) Filed: Aug. 16, 2005

(30) Foreign Application Priority Data
Aug. 17, 2004 (KR) 10-2004-0064590

(51) Int. Cl. B01L 3/00

(52) U.S. Cl. 436/180; 422/100

(57) ABSTRACT

Provided are an inkjet-type spotting apparatus for manufacturing microarrays and a method of spotting using the same. The spotting apparatus includes a plurality of reservoirs which are arranged in rows and filled with a predetermined biomolecule solution; and a plurality of nozzles, each corresponding to one of the reservoirs and through which the biomolecule solution is ejected, wherein a distance between the nozzles in a first direction is larger than a distance between spots in a spot array, and the biomolecule solution is ejected sequentially from the nozzles in each of the rows onto a solid support while the apparatus moves in the first direction to form the spot array.

### BACKGROUND OF THE INVENTION

This application claims the benefit of Korean Patent Application No. 10-2004-0064590, filed on Aug. 17, 2004, in the Korean Intellectual Property Office, the disclosure of which is incorporated herein in its entirety by reference.

1. Field of the Invention

The present invention relates to an inkjet spotting apparatus for manufacturing microarrays and a method of spotting using the same.

2. Description of the Related Art

Microrrays or biochips are microchips which have biomolecules, such as probe DNAs or proteins, immobilized at a high density on predetermined regions of a solid substrate thereof. Microarrays play a very important role in bioengineering fields including diagnosis of diseases, development of new drugs, identification of nucleic acid sequences, etc.

A conventional method of producing microarrays comprises contacting a surface of a solid support with a pin containing a biomolecule solution. However, in such a method, a tip of the pin and the surface of the solid support are deformed due to physical contact, and thus, uniformity of the microarrays is deteriorated. Recently, apparatuses for manufacturing microarrays which spot a biomolecule solution on a solid support in a non-contact manner using inkjetting have been developed.

FIG. 1 is a partial cut-away perspective view of a conventional inkjet spotting apparatus for manufacturing microarrays. Referring to FIG. 1, the conventional spotting apparatus comprises a plurality of reservoirs 10 which are filled with a predetermined biomolecule solution which is injected from the outside, a plurality of nozzles 12 through which the biomolecule solution is ejected, and a plurality of microchannels 14 connecting the reservoirs 10 to the nozzles 12. The distancees between the nozzles 12 are equivalent to the distancees between spots in the microarray.

However, in the conventional spotting apparatus, the size of the reservoirs 10 (about several mm) are much larger than size of the nozzles 12 (about 20 μm) and the distancees between the reservoirs 10 (about several mm) are much larger than the distancees between the nozzles 12 (about 150 μm). Thus, the microchannels 14 connecting the reservoirs 10 to the nozzles 12 are very complicated and long. As a result, it is difficult for the biomolecule solution to be supplied from the reservoirs 10 to the nozzles 12 with ease.

### SUMMARY OF THE INVENTION

The present invention provides a spotting apparatus for manufacturing microarrays, the spotting apparatus having a simplified channel structure, and a method of spotting using the same.

According to an aspect of the present invention, there is provided a spotting apparatus for manufacturing microarrays, the spotting apparatus comprising: a plurality of reservoirs which are arranged in rows and filled with a predetermined biomolecule solution; and a plurality of nozzles, each corresponding to one of the reservoirs and through which the biomolecule solution is ejected, wherein a distance between the nozzles in a first direction is larger than a distance between spots in a spot array, and the biomolecule solution is ejected sequentially from the nozzles in each of the rows onto a solid support while the apparatus moves in the first direction to form the spot array.

The nozzles which constitute a row may be arranged to be inclined to the first direction.

The distance between the nozzles in the first direction may be substantially the same as a distance between the reservoirs which correspond to the nozzles. The reservoirs which correspond to the nozzles may be arranged in the first direction. The distance between the nozzles in the first direction may be several mm, preferably 1-5 mm.

A distance between the nozzles in a second direction may be substantially the same as the distance between the spots in the first direction. The second direction may be perpendicular to the first direction. The distance between the nozzles in the second direction may be 30-300 μm.

The spotting apparatus may further comprise a plurality of channels connecting the reservoirs to the nozzles.

The spotting apparatus may comprise a first substrate having the reservoirs; and a second substrate having the nozzles. The second substrate may further have a plurality of channels connecting the reservoirs to the nozzles.

The first substrate may be made of glass. The second substrate may be made of silicon. The reservoirs may have a circular, quadrangular or hexagonal cross-section.

The biomolecule solution may contain nucleic acids or proteins. The nucleic acids may comprise probe DNAs.

The spotting apparatus may eject the biomolecule solution using an inkjet method. The inkjet method may be a thermal, piezoelectric, or electrostatic inkjet method.

According to another aspect of the present invention, there is provided a method of spotting using a spotting apparatus for manufacturing microarrays, the spotting apparatus comprising: a plurality of reservoirs which are arranged in rows and filled with a predetermined biomolecule solution; and a plurality of nozzles each corresponding to one of the reservoirs and through which the biomolecule solution is ejected, wherein a distance between the nozzles in a first direction is larger than a distance between spots in a spot array, the method comprising ejecting the biomolecule solution sequentially from the nozzles in each of the rows onto a solid support while the spotting apparatus moves in the first direction.

In the method, the biomolecule solution may be ejected sequentially from the nozzles in a row on the solid support while the spotting apparatus moves in the first direction, to form a spot column in the second direction on the solid substrate. The second direction may be perpendicular to the first direction.

### BRIEF DESCRIPTION OF THE DRAWINGS

The above and other features and advantages of the present invention will become more apparent by describing in detail exemplary embodiments thereof with reference to the attached drawings in which:

FIG. 1 is a partial cut-away perspective view of a conventional spotting apparatus for manufacturing microarrays;

FIG. 2 is a partial top view of a spotting apparatus for manufacturing microarrays according to an embodiment of the present invention;

FIG. 3 is a cross-sectional view taken along line III-III′ of the apparatus illustrated in FIG. 2;

FIG. 4 is a top view of the spotting apparatus for manufacturing microarrays illustrated in FIG. 2;

FIG. 5 is a view illustrating spot columns formed by a biomolecule solution ejected from the spotting apparatus illustrated in FIG. 4; and

FIGS. 6A through 6H are views illustrating a method of manufacturing microarrays using the spotting apparatus according to an embodiment of the present invention.

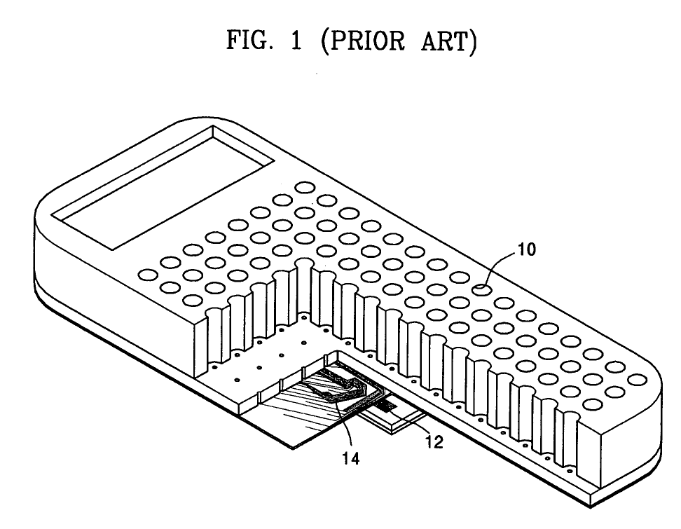

### DETAILED DESCRIPTION OF THE INVENTION

Hereinafter, exemplary embodiments of the present invention will be described in detail with reference to the attached drawings. Throughout the drawings, like reference numerals denote like elements. The first direction and the second direction described above will be exemplified as an x-direction and a y-direction in the drawings, respectively.

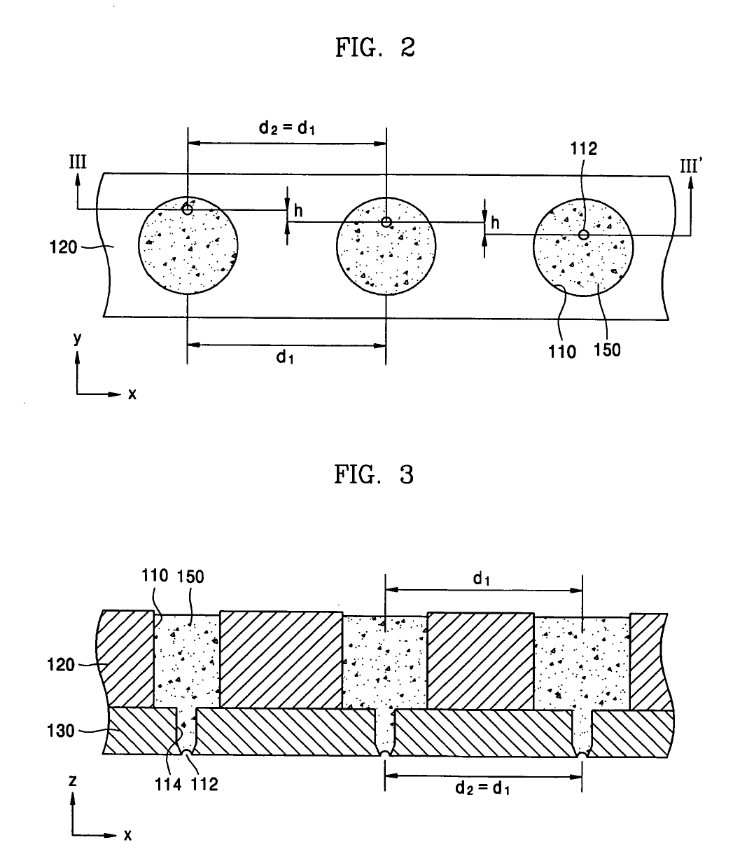

FIG. 2 is a partial top view of a spotting apparatus for manufacturing microarrays according to an embodiment of the present invention. FIG. 3 is a cross-sectional view taken along line III-III′ of the apparatus illustrated in FIG. 2.

Referring to FIGS. 2 and 3, the spotting apparatus for manufacturing microarrays according to an embodiment of the present invention includes a first substrate 120 and a second substrate 130 which the first substrate 120 is formed on. The first substrate 120 may be a glass substrate and the second substrate 130 may be a silicon wafer. The first substrate 120 and the second substrate 130 may be manufactured in an integrated structure.

A plurality of reservoirs 110 are formed in the first substrate 120. The reservoirs 110 are filled with a predetermined biomolecule solution 150, which is injected from the outside. Each of the reservoirs 110 may have a circular cross-section as illustrated in FIG. 2 or a quadrangular or hexagonal cross-section, etc. Each of the reservoirs 110 may have a diameter of about several mm. The reservoirs 110 are arranged separated by a predetermined distance d along the x-direction. The distance d between the reservoirs 110 may be about several mm, preferably about 1-5 mm.

A plurality of nozzles 112 through which the biomolecule solution 150 is ejected are formed in a bottom portion of the second substrate 130. The nozzles 12 correspond to the reservoirs 110. Each of the nozzles 112 may have a diameter of about 20 μm. A plurality of channels 114 connecting the reservoirs 110 to the nozzles 112 are formed in a top portion of the second substrate 130.

The nozzles 112 are arranged inclined to the x-direction at a predetermined angle. A distance d₂ between the nozzles 112 in the x-direction may be larger than a distance between spots in a spot array to be formed on the microarray. The distance d₂ between the nozzles 112 in the x-direction may be substantially the same as the distance d₁ between the reservoirs 110, as illustrated in FIGS. 2 and 3. Thus, in this case, the distance d₂ between the nozzles 112 in the x-direction may be about several mm, preferably about 1-5 mm. When the distance d₂ between the nozzles 112 in the x-direction is the same as the distance d between the reservoirs 110, the channels 114 may be shortened and have the more simplified structure, and thus, the biomolecule solution 150 may be supplied from the reservoirs 110 to the nozzles 112 through the channels 114 with ease. A distance h between the nozzles 112 in the y-direction may be substantially the same as the distance between the spots. In this case, the distance h between the nozzles 112 in the y-direction may be 30-300 μm.

The spotting apparatus for manufacturing microarrays according to an embodiment of the present invention ejects the biomolecule solution using an inkjet method. The inkjet method may be a thermal, piezoelectric, or electrostatic inkjet method.

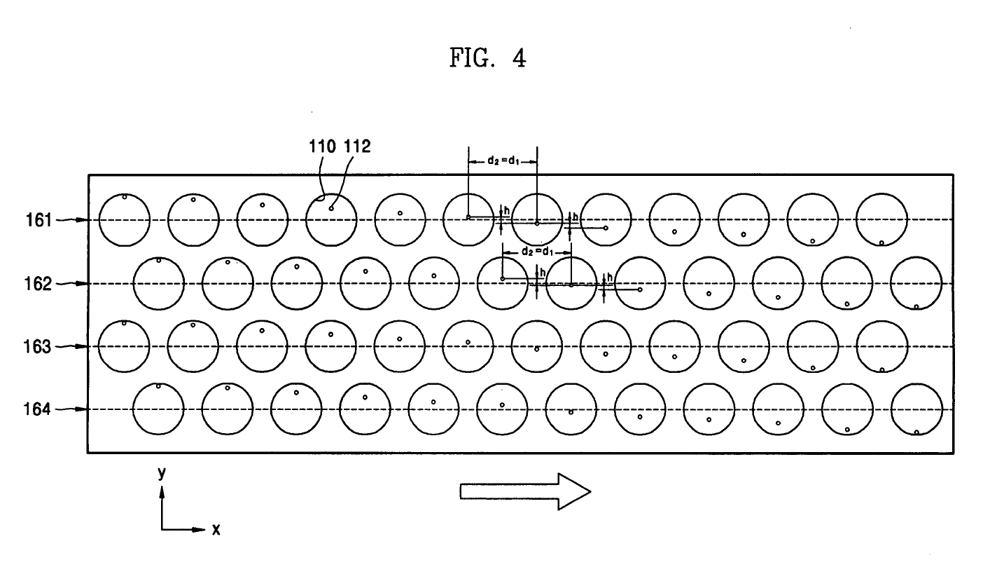

FIG. 4 illustrates the inkjet-type spotting apparatus for manufacturing microarrays, which adopts the arrangement of reservoirs and nozzles as illustrated in FIGS. 2 and 3. Referring to FIG. 4, the reservoirs 110 are arranged in four rows, i.e., a first reservoir row 161, a second reservoir row 162, a third reservoir row 163, and a fourth reservoir row 164. Each of the first through fourth reservoir rows 161, 162, 163, and 164 includes twelve of the reservoirs 110 arranged separated by the distance d in the x-direction. The nozzles 112 are arranged in four rows, the nozzles 112 corresponding to the reservoirs 110. In this case, twelve of the nozzles 112 which constitute a row are arranged to be inclined to the x-direction by a predetermined angle. The distance d₂ between the nozzles 112 in the x-direction may be the same as distance d between the reservoirs 110. The distance h between the nozzles 112 in the y-direction may be the same as the distance between the spots in the microarray to be manufactured.

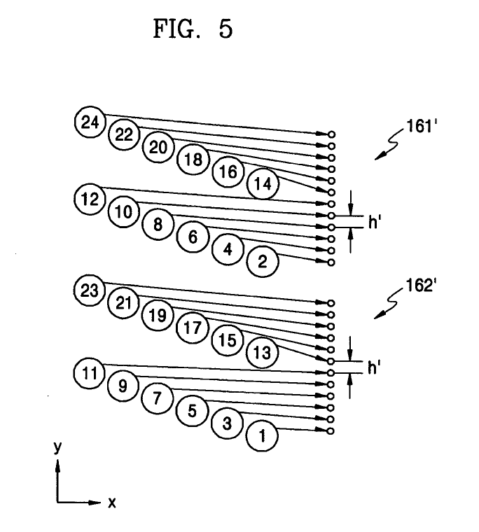

The spotting apparatus having this structure produces a spot array by ejecting the biomolecule solution sequentially from the nozzles 112 on the solid support. Specifically, referring to FIG. 4, when the biomolecule solution is ejected on predetermined locations of a solid support sequentially from the nozzles 112 in all of the reservoir rows 161, 162, 163, and 164 at predetermined time intervals while the spotting apparatus moves in the x-direction, spot columns are formed in the y-direction on the spot array. Referring to FIG. 5, the biomolecule solution is ejected sequentially from twenty-four nozzles 112 of the first reservoir row 161 and the second reservoir row 162, thus forming a first spot column 161′ and a second spot column 162′ in the y-direction. In FIG. 5, reference numerals 1 through 24 indicate the order in which spots are formed. The first spot column 161′ and the second spot column 162′ correspond to the first reservoir row 161 and the second reservoir row 162, respectively. A distance h′ between the spots arranged in each of the first spot column 161′ and the second spot column 162′ is the same as the distance h between the nozzles 112 in each of the nozzle rows 161 and 162, in the y-direction.

Although FIG. 4 illustrates a spotting apparatus for manufacturing microarrays comprising four reservoir rows with twelve reservoirs being arranged in each reservoir row in the x-direction, the spotting apparatus for manufacturing microarrays according to the present invention is not limited thereto and various changes can be made therein.

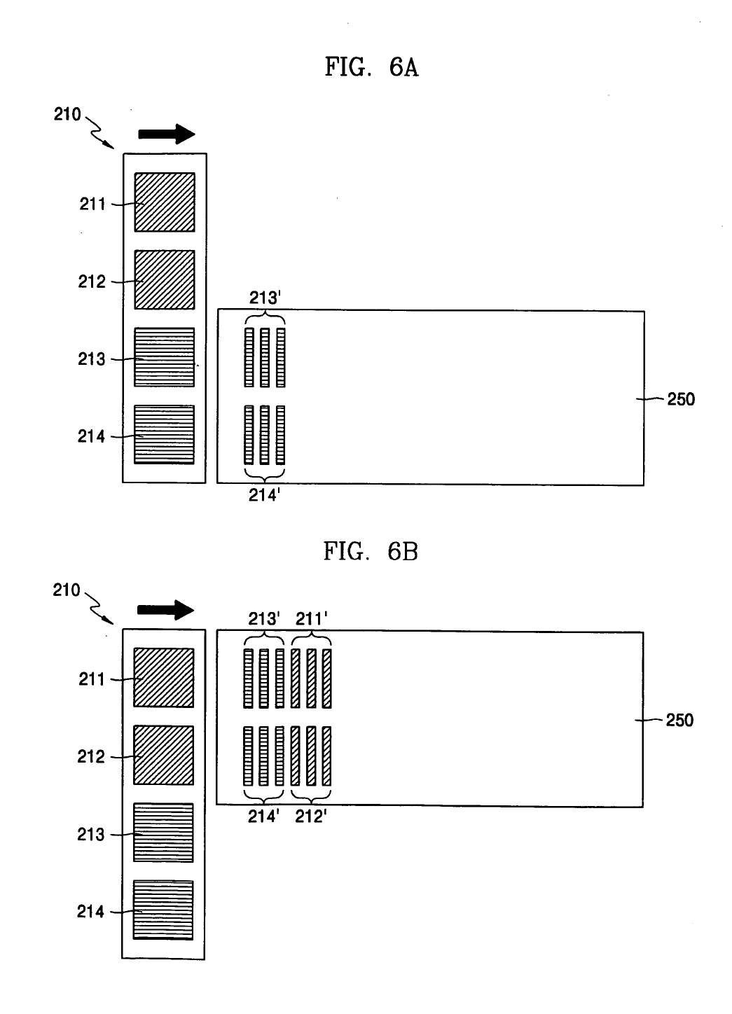

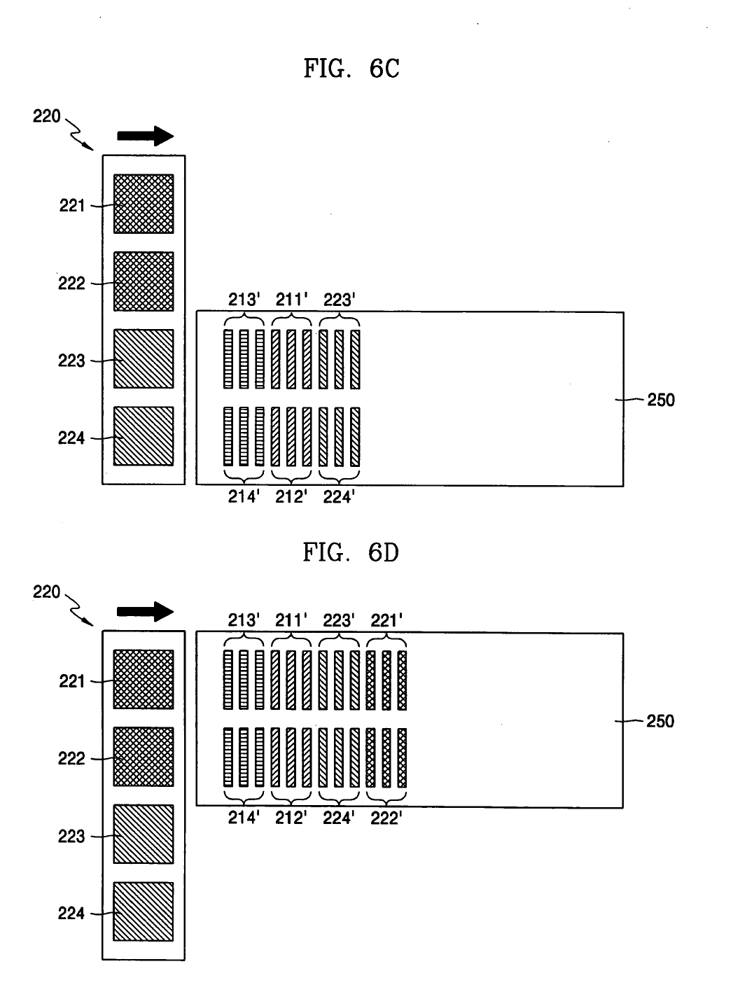

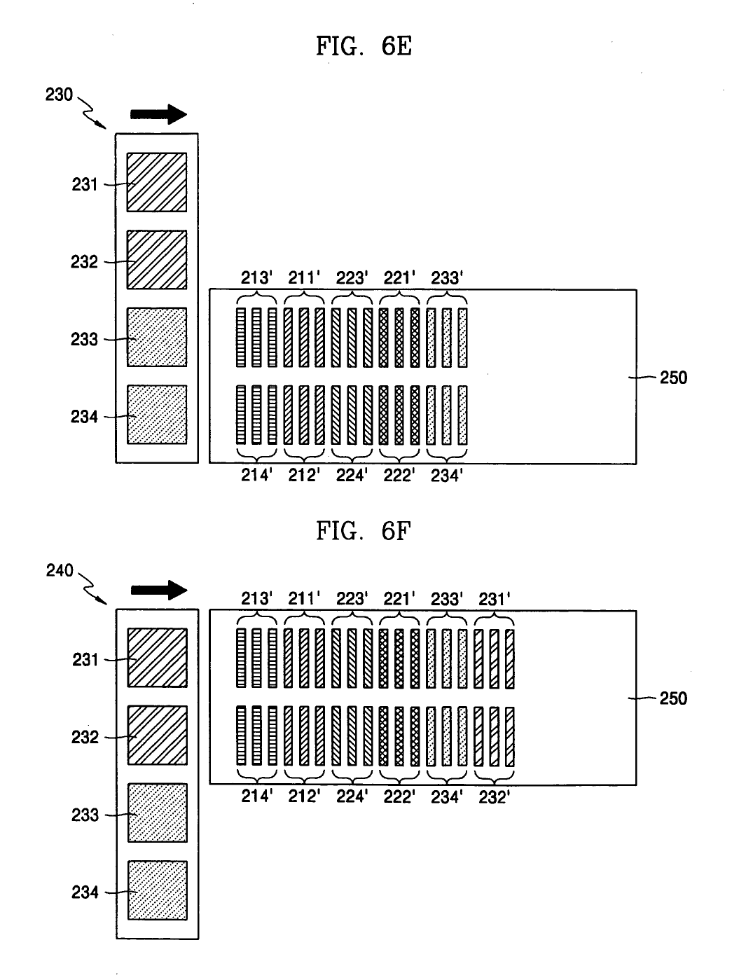

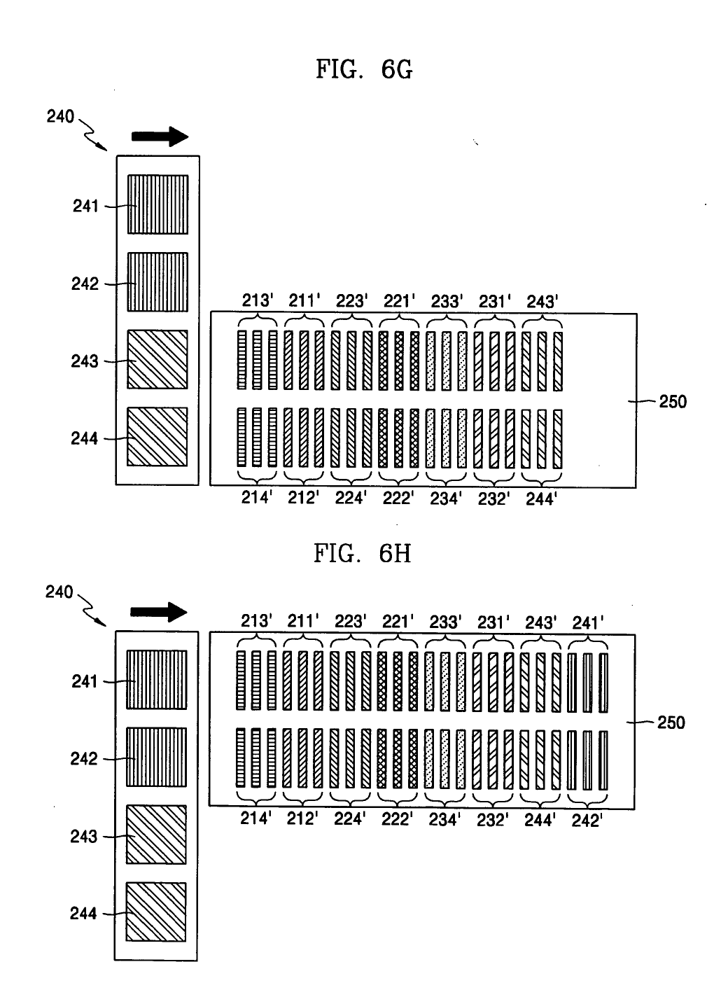

FIGS. 6A through 6H are views illustrating a method of manufacturing microarrays using the spotting apparatus according to an embodiment of the present invention. In FIGS. 6A through 6H, four spotting apparatuses are used to manufacturing a microarray. Each spotting apparatus comprises four units and each unit comprises a row of reservoirs and nozzles corresponding to the respective reservoirs, as described above.

Referring to FIG. 6A, when a biomolecule solution is spotted on a solid support 250 sequentially from a third unit 213 and a fourth unit 214 while a first spotting apparatus 210 moves in an arrow direction, spot columns 213′ and 214′ which correspond to the third unit 213 and the fourth unit 214, respectively, are formed on predetermined locations of the solid support 250. Next, as illustrated in FIG. 6B, the first spotting apparatus 210 moves down by a predetermined distance such that the first and second units 211 and 212 are aligned with the solid support 250. Then, when the biomolecule solution is spotted on the solid support 250 sequentially from the first unit 211 and the second unit 212 while the first spotting apparatus 210 moves in the arrow direction, spot columns 211′ and 212′ which correspond to the first unit 211 and the second unit 212, respectively, are formed on predetermined locations of the solid support 250.

Subsequently, the first spotting apparatus 210 is replaced with a second spotting apparatus 220, and referring to FIG. 6C, while the second spotting apparatus 220 moves in the arrow direction, spot columns 223′ and 224′ which correspond to a third unit 223 and a fourth unit 224, respectively, are formed on predetermined locations of the solid support 250. Next, as illustrated in FIG. 6D, the second spotting apparatus 220 moves down by a predetermined distance such that the first and second units 221 and 222 are aligned with the solid support 250. Then, while the second spotting apparatus 220 moves in the arrow direction, spot columns 221′ and 222′ which correspond to the first unit 221 and the second unit 222, respectively, are formed on predetermined locations of the solid support 250.

Subsequently, the second spotting apparatus 220 is replaced with a third spotting apparatus 230, and referring to FIG. 6E, while the third spotting apparatus 230 moves in the arrow direction, spot columns 233′ and 234′ which correspond to a third unit 233 and a fourth unit 234, respectively, are formed on predetermined locations of the solid support 250. Next, as illustrated in FIG. 6F, the third spotting apparatus 230 moves down by a predetermined distance such that the first and second units 231 and 232 are aligned with the solid support 250. Then, while the third spotting apparatus 230 moves in the arrow direction, spot columns 231′ and 232′ which correspond to the first unit 231 and the second unit 232, respectively, are formed on predetermined locations of the solid support 250.

Subsequently, the third spotting apparatus 230 is replaced with a fourth spotting apparatus 240, and as referring to FIG. 6G, while the fourth spotting apparatus 240 moves in the arrow direction, spot columns 243′ and 244′ which correspond to a third unit 243 and a fourth unit 244, respectively, are formed on predetermined locations of the solid support 250. Next, as illustrated in FIG. 6H, the fourth spotting apparatus 240 moves down by a predetermined distance such that the first and second units 2411 and 242 are aligned with the solid support 250. Then, while the fourth spotting apparatus 240 moves in the arrow direction, spot columns 241′ and 242′ which correspond to the first unit 241 and the second unit 242, respectively, are formed on predetermined locations of the solid support 250. Thus, a predetermined spot array is formed on the solid support 250 to manufacture the microarray.

The microarray can be manufactured in a relatively short time by using the inkjet spotting apparatus for manufacturing microarrays according to the present invention, as described above. For example, when the spotting apparatus for manufacturing microarrays according to the present invention is used on a 6-inch wafer, 96 microarrays each having a size of 12 mm×12 mm can be manufactured within about 10 minutes.

As described above, the spotting apparatus for manufacturing microarrays according to the present invention and the method of spotting using the same have the following effects:

First, the distance between the nozzles is substantially the same as the distance between the reservoirs, and thus, the channels connecting the reservoirs to the nozzles may be shortened and have a more simplified structure. Accordingly, the biomolecule solution may be supplied from the reservoirs to the nozzles with ease.

Second, due to the more simplified structure of the channels, the manufacturing process performed by the apparatus can be simplified and the yield can be increased.

Third, microarrays can be mass-produced by the apparatus in a relatively short time.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A spotting apparatus for manufacturing microarrays, the spotting apparatus comprising: a plurality of reservoirs which are arranged in rows and filled with a predetermined biomolecule solution; and a plurality of nozzles, each corresponding to one of the reservoirs and through which the biomolecule solution is ejected, wherein a distance between the nozzles in a first direction is larger than a distance between spots in a spot array, and the biomolecule solution is ejected sequentially from the nozzles in each of the rows onto a solid support while the apparatus moves in the first direction to form the spot array.

2. The spotting apparatus of claim 1, wherein the nozzles which constitute a row are arranged to be inclined to the first direction.

3. The spotting apparatus of claim 2, wherein the distance between the nozzles in the first direction is substantially the same as a distance between the reservoirs which correspond to the nozzles.

4. The spotting apparatus of claim 3, wherein the reservoirs which correspond to the nozzles are arranged in the first direction.

5. The spotting apparatus of claim 3, wherein the distance between the nozzles in the first direction is several mm.

6. The spotting apparatus of claim 5, wherein the distance between the nozzles in the first direction is 1-5 mm.

7. The spotting apparatus of claim 2, wherein a distance between the nozzles in a second direction is substantially the same as the distance between the spots in the first direction.

8. The spotting apparatus of claim 7, wherein the second direction is perpendicular to the first direction.

9. The spotting apparatus of claim 8, wherein the distance between the nozzles in the second direction is 30-300 μm.

10. The spotting apparatus of claim 1, further comprising a plurality of channels connecting the reservoirs to the nozzles.

11. The spotting apparatus of claim 1, comprising: a first substrate having the reservoirs; and a second substrate having the nozzles.

12. The spotting apparatus of claim 11, wherein the second substrate further has a plurality of channels connecting the reservoirs to the nozzles.

13. The spotting apparatus of claim 11, wherein the first substrate is made of glass.

14. The spotting apparatus of claim 11, wherein the second substrate is made of silicon.

15. The spotting apparatus of claim 1, wherein the reservoirs have a circular, quadrangular or hexagonal cross-section.

16. The spotting apparatus of claim 1, wherein the biomolecule solution contains nucleic acids or proteins.

17. The spotting apparatus of claim 16, wherein the nucleic acids comprise probe DNAs.

18. The spotting apparatus of claim 1, ejecting the biomolecule solution using an inkjet method.

19. The spotting apparatus of claim 18, wherein the inkjet method is a thermal, piezoelectric, or electrostatic inkjet method.

20. A method of spotting using a spotting apparatus for manufacturing microarrays, the spotting apparatus comprising: a plurality of reservoirs which are arranged in rows and filled with a predetermined biomolecule solution; and a plurality of nozzles each corresponding to one of the reservoirs and through which the biomolecule solution is ejected, wherein a distance between the nozzles in a first direction is larger than a distance between spots in a spot array,
the method comprising ejecting the biomolecule solution sequentially from the nozzles in each of the rows onto a solid support while the spotting apparatus moves in the first direction.

21. The method of claim 20, wherein the nozzles which constitute a row are arranged to be inclined to the first direction.

22. The method of claim 21, wherein the distance between the nozzles in the first direction is substantially the same as a distance between the reservoirs which correspond to the nozzles.

23. The method of claim 21, wherein a distance between the nozzles in a second direction is substantially the same as the distance between the spots.

24. The method of claim 23, wherein the second direction is perpendicular to the first direction.

25. The method of claim 24, wherein the biomolecule solution is ejected sequentially from the nozzles in a row on the solid support while the spotting apparatus moves in the first direction, to form a spot column in the second direction on the solid substrate.

26. The method of claim 25, wherein a distance between the spots in the spot column is 30-300 μm.

27. The method of claim 20, wherein the biomolecule solution contains nucleic acids or proteins.

28. The method of claim 27, wherein the nucleic acids comprise probe DNAs.

29. The method of claim 20, wherein the biomolecule solution is ejected using an inkjet method.

30. The method of claim 29, wherein the inkjet method is a thermal, piezoelectric, or electrostatic inkjet method.

31. The method of claim 20, comprising spotting by sequentially using a plurality of the spotting apparatuses.
